(19) United States
(12) Patent Application Publication
(10) Pub. No.: US 2013/0014550 A1
(43) Pub. Date: Jan. 17, 2013

(54) Electromagnetic Induction (/Rifidi) Suitcase (Including Luggage & Bag) Lock

(71) Applicants: Deyi Xie, Zhuhai City (CN); Songjun Zhai, Guangdong (CN)

(72) Inventors: Deyi Xie, Zhuhai City (CN); Songjun Zhai, Guangdong (CN)

(73) Assignee: SKYGOOD TECH INDUSTRIAL CO., LTD., Zhuhai City (CN)

(21) Appl. No.: 13/352,517

(22) Filed: Jan. 18, 2012

(30) Foreign Application Priority Data
Apr. 27, 2011 (CN) 201120129322.8

(51) Int. Cl. E05B 65/52; E05B 47/02

(52) U.S. Cl. 70/69

(57) ABSTRACT

An electromagnetic induction (/Rifidi) suitcase (including luggage & bag) lock which comprises a shell is provided. The suitcase contains at least one buckle lock set arranged in the shell, which is used to buckle the parts to be locked; a locking component arranged in the shell, which is used to lock or release the buckle lock set; and an electromagnetic induction (/Rifidi) component arranged in the shell, which is used to sense the signal and thus control the operation of the locking component.

### CROSS REFERENCE TO RELATED APPLICATION

This application claims priority to and the benefit of Chinese Patent Application No. 201120129322.8 filed in the Chinese Intellectual Property Office on Apr. 27, 2011, the entire contents of which is incorporated herein by reference.

### FIELD OF THE INVENTION

The present invention relates to a suitcase (including luggage & bag) lock, particularly relates to an electromagnetic induction (/Rifidi) suitcase (including luggage & bag) lock.

### DESCRIPTION OF THE RELATED ART

Currently, most of the suitcase (including luggage & bag) locks are unlocked by adjusting the password wheels or keys, but users often forget the password. Thus, users are not able to unlock the suitcase, which causes trouble. For suitcase (including luggage & bag) locks with keys, it is required that the user bring a key. While many locks have adopted electromagnetic induction (/Rifidi) technology without a key, a lot of people do not have the habit of bringing a key, and so the additional keys thus are inconvenience to users.

### SUMMARY OF THE INVENTION

The technical problem to be solved by the present invention is to provide a convenient electromagnetic induction (/Rifidi) suitcase (including luggage & bag) lock.

The above technical problem is solved by the following technical solutions:
an electromagnetic induction (/Rifidi) suitcase (including luggage & bag) locks including a housing, which is characterized by that it also comprises:
at least one buckle lock set arranged in the shell, which is used to buckle the parts to be locked;

a locking component arranged in the shell, which is used to lock or release the buckle lock set;

and an electromagnetic induction (/Rifidi) component arranged in the shell, which is used to sense the signal and thus control the operation of the locking component.

The locking component comprises a motor component controlled by the electromagnetic induction (/Rifidi) component, a rotatable rotating stop block and a driving spring. The motor component drive the rotating stop block in coordinate with the driving spring, thus locking or releasing the buckle lock set.

The motor component comprises a motor controlled by the electromagnetic induction (/Rifidi) component, a turbine provided on the motor shaft and a pushing component driven by the turbine; the pushing component driving the rotating stop block in coordination with the driving spring, thus locking or releasing the buckle lock set.

The pushing component comprises a driving elastic component provided with a ring and a double-arm connected with the ring, a guide rod, a hollow “H” shaped guide wheel and a push plate. The guide rod and pushing plate are respectively fitted on each side of the turbine, wherein the guide wheel is fitted through the guide rod, the ring of driving elastic component is fitted over the guide wheel, and the double arm of the driving elastic component is placed to hold the turbine and fitted on the pushing plate.

The pushing component comprises a push spring and a push block, wherein the push spring is fitted onto the turbine with one end fixed and another end fixed on the push block; the push block driving the rotating stop block in coordination with the driving spring, thus locking or releasing the buckle lock set.

The electromagnetic induction (/Rifidi) component comprises a battery providing working power supply, a control circuit board and an induction (/Rifidi) coil connected with the control circuit board.

The electromagnetic induction (/Rifidi) component also comprises an indicating light provided with two indication state and connected with the control circuit board.

The control circuit board is provided with a low voltage detect circuit, wherein the low voltage detect circuit comprises a detection module used for detecting the voltage of the battery and a control module used for controlling the locking component, thus the buckle lock set is released when the battery voltage is under the pre-set value.

The buckle lock set comprises: a buckling component used for buckling the parts to be locked; an unlock pulling plate arranged in the shell which is pulled by user from outside of the shell. Thus, the buckling component is correspondingly pulled and the parts to be locked are released. A return spring component is arranged in the shell, which is used for driving the buckling component to buckle the parts to be locked; the locking component locking or releasing the buckling component.

The buckling component comprises a first pull rod with first buckle and a second pull rod with second buckle, while the return spring component comprises a first return spring connected with the first pull rod and a second return spring connected with the second pull rod.

The buckle lock set comprises: a rotatable torque part; a buckling linkage structure used to buckle the parts to be locked; a linkage plate, which is provided with a trip used to lock the buckling linkage structure; a return spring used to drive the linkage plate to lock the buckling linkage structure and set against the torque part; and a push button used to press the torque part, which accordingly drives the linkage plate to release the buckling linkage structure. The locking component locks or releases the linkage plate.

The buckling linkage structure comprises a side lock cover, an elastic joint plate and a side lock latch hook used for buckling the parts to be locked. The fixed joint plate is fixed in the shell. One end of the elastic joint plate is rotationally connected to the fixed joint plate, and another end of the elastic joint plate is rotationally connected to the middle of the side lock cover. One end of the side lock cover is rotationally connected to the shell, and another end of the side lock cover is coordinated with the trip of the linkage plate. The side lock cover drives the side lock latch hook to buckle the parts to be locked and compress the elastic joint plate, whereas the elastic joint plate repositions and prop the side lock cover, thus the side lock cover drives the side lock latch hook to release the parts to be locked.

The quantity of the buckle lock set is two, the two buckle lock sets are respectively provided at each side of the locking component which lock or release the two linkage plate simultaneously.

In the present invention, the operation of locking component is controlled through setting the electromagnetic induction (/Rifidi) component. Further, the buckle lock set used for buckling the parts to be locked is controlled, thus the object of releasing and locking the parts to be locked is achieved. Users only need a magnetic card compatible with the electromagnetic induction (/Rifidi) component of the present invention to achieve lock up and unlock, which is very convenient. In the present invention, a low voltage detect circuit is provided, which is used to avoid being incapable of unlocking when the battery runs out of power.

### BRIEF DESCRIPTION OF THE DRAWINGS

FIG. 1 is an exploded view of the first embodiment of the present invention;

FIG. 2 is an assembly drawing of the first embodiment of the present invention;

FIG. 3 is a drawing illustrating the lockup state of the first embodiment of the present invention;

FIG. 4 is a drawing illustrating the unlock state of the first embodiment of the present invention;

FIG. 5 is an exploded view of the second embodiment of the present invention;

FIG. 6 is an assembly drawing of the second embodiment of the present invention;

FIG. 7 is a drawing illustrating the lockup state of the second embodiment of the present invention;

FIG. 8 is an unlock state drawing of the second embodiment of the present invention;

FIG. 9 is an exploded view of the third embodiment of the present invention;

FIG. 10 is a constructional drawing of the locking component of the third embodiment of the present invention;

FIG. 11 is a constructional drawing of the left side buckle lock set of the third embodiment of the present invention;

FIG. 12 is a sketch showing the position of the return spring of the third embodiment of the present invention;

FIG. 13 is a constructional drawing of the locking component and two buckle lock sets of the third embodiment of the present invention;

FIG. 14 is a constructional drawing of the locking component and left side buckle lock set of the third embodiment of the present invention;

FIG. 15 is a side view of the locking component and the electromagnetic induction (/Rifidi) component of the third embodiment of the present invention;

FIG. 16 is a front view of the locking component and the electromagnetic induction (/Rifidi) component of the third embodiment of the present invention;

FIG. 17 is a sketch of the low voltage detects circuit of the third embodiment of the present invention.

### DESCRIPTION OF THE PREFERRED EMBODIMENT

### The First Embodiment

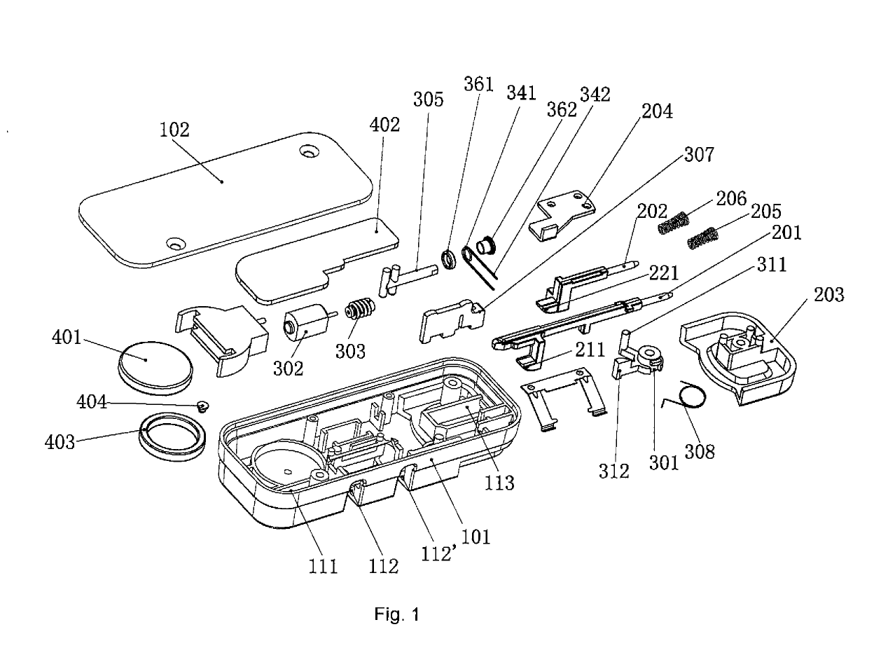

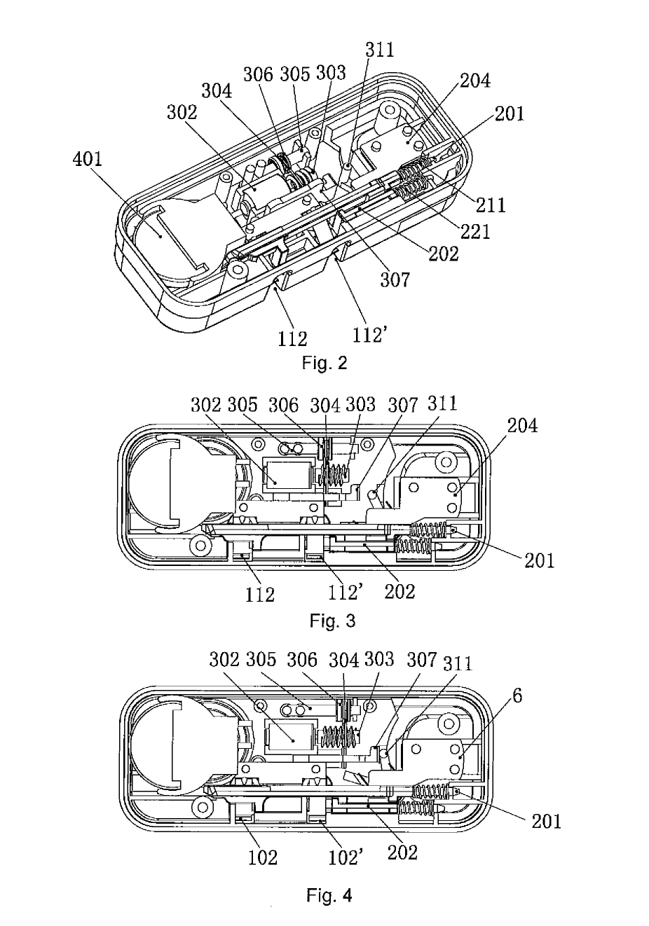

As shown in FIG. 1 and FIG. 2, the present invention comprises:

A shell, which comprises an upper shell 101 and a base plate 102, wherein the upper shell 101 is provided with an installing opening 111, two lockup openings 112, 112′ and an unlock opening 113, while the base plate 102 is installed at the installing opening 111.

A buckle lock set is also arranged in the shell, which comprises a buckling component fitted in the shell, an unlock pulling plate 203 and a return spring component. The buckling component comprises a first pull rod 201 provided with first buckle 211 and a second pull rod 202 provided with second buckle 221, both of which are parallely provided at lockup opening 112 and lockup opening 112′ so the parts to be locked can be buckled. The unlock pulling plate 203 is fitted at the unlock opening 113 from outside of the shell and connected to an internal pull plate 204, which buckles the first pull rod 201 and second pull rod 202. The return spring component comprises the first return spring 205 connected with the first pull rod 201 and the second return spring 206 connected with the second pull rod 202.

A locking component is arranged in the shell, which comprises a motor component, a rotating stop block 301 with two swing arms 311 and 312 and a driving spring 308, wherein the motor component comprises a motor 302, a turbine 303 provided in the motor rotating shaft and a pushing component driven by the turbine 303. The pushing component comprises a driving elastic component 304 provided with a ring 341 and a double-arm 342 connected with the ring 341, a guide rod 305, a hollow “H” shaped guide wheel 306 and a push plate 307. The guide wheel 306 comprises a guide ring 361 and a hollow inverted T shaped guide tube 362 coupled with the guide ring 361. The driving elastic component 304 could be formed by folding a circle at the middle of a spring. The guide rod 305 and pushing plate 307 are respectively fitted on each side of the turbine 303, wherein the guide wheel 306 is fitted through the guide rod 305, the ring 341 of driving elastic component 304 is fitted over the guide wheel 306, the double arm 342 of the driving elastic component 304 is placed to hold the turbine 303 and fitted on the pushing plate 307. The motor component and driving spring 308 coordinately drive the rotating stop block 301 to lockup or release the pull rod 201 and second pull rod 202.

An electromagnetic induction (/Rifidi) component is fitted in the shell, which comprises a battery 401 used for providing working power supply, a control circuit board 402, an induction (/Rifidi) coil 403 connected with the control circuit board 402, an indicating light 404 with two indication state (displaying red and green).

The principle of operation of the present invention is:

As shown in FIG. 3, lockup state: The push plate 307 releases the swing arm 311 of the rotating stop block 301, thus the driving spring 308 is in initial condition, the swing arm 312 of the rotating stop block 301 is set against the first pull rod 201 and second pull rod 202, both of which are locked and cannot move.

Unlock process: When the magnetic card is placed on the shell of the present invention (close to the induction (/Rifidi) coil 403), the electromagnetic induction (/Rifidi) component induces the signal, which then controls the indicating light 404 to display green, drives the motor 302 to rotate and drives the turbine 303 to make clockwise rotation (the turbine 303 could be also designed to make counterclockwise rotation in unlock process). The turbine 303 rotates and drives the driving elastic component 304, which moves forward by the aid of guide wheel 306 and the guide lever 305. Driven by the driving elastic component 304, the push plate 307 moves forward and pushes against the swing arm 311 of the rotating stop block 301, which rotates and simultaneously strain the driving spring 308, thus the swing arm 312 of the rotating stop block 301 leaves the first pull rod 201 and the second pull rod 202. The present invention is in unlock state at the moment, users can pull the unlock pulling plate 203, which moves and drives the first pull rod 201 and the second pull rod 202 to move by internal pull plate 204, thus the first buckle 211 and the second buckle 221 release the locked parts, simultaneously the first return spring 205 and the second return spring 206 are compressed.

As shown in FIG. 4, unlock state: The push plate 307 pushes against the swing arm 311 of the rotating stop block 301, the driving spring 308 is in strained condition, the swing arm 312 of the rotating stop block 301 leaves the first pull rod 201 and the second pull rod 202. Users can pull the unlock pulling plate 203 to drive the first pull rod 201 and the second pull rod 202.

Locking process: In the condition that the unlock pulling plate 203 is not pulled, the first return spring 205 and the second return spring 206 are in initial condition, both of which push the first buckle 211 and the second buckle 221 to the lockup opening 112, 112′. Under this condition, when users place the magnetic card on the shell of the present invention (close to the induction (/Rifidi) coil 403), the electromagnetic induction (/Rifidi) component induces the signal, which then controls the indicating light 404 to display red, drives the motor 302 to rotate and drives the turbine 303 to make counterclockwise rotation (opposite to the rotation in unlock process). The turbine 303 rotates and drives the driving elastic component 304, which moves backward by the aid of guide wheel 306 and the guide lever 305. Driven by the driving elastic component 304, the push plate 307 moves backward and releases the swing arm 311 of the rotating stop block 301, simultaneously the driving spring 308 restores to its initial state, the rotating stop block 301 then rotates, thus the swing arm 312 of the rotating stop block 301 is set against the first pull rod 201 and the second pull rod 202. The present invention is in lockup state at the moment, the first pull rod 201 and the second pull rod 202 are locked and can not move.

In the present invention, once the induction (/Rifidi) coil 403 induces the magnetic card and drives the motor 302 to make anticlockwise rotation, then next time the induction (/Rifidi) coil 403 will induce the magnetic card and drive the motor 302 to make clockwise rotation. This means the turbine 303 makes counterclockwise and clockwise rotation in turns, correspondingly the push plate 307 moves backward and forward in turns.

### The Second Embodiment

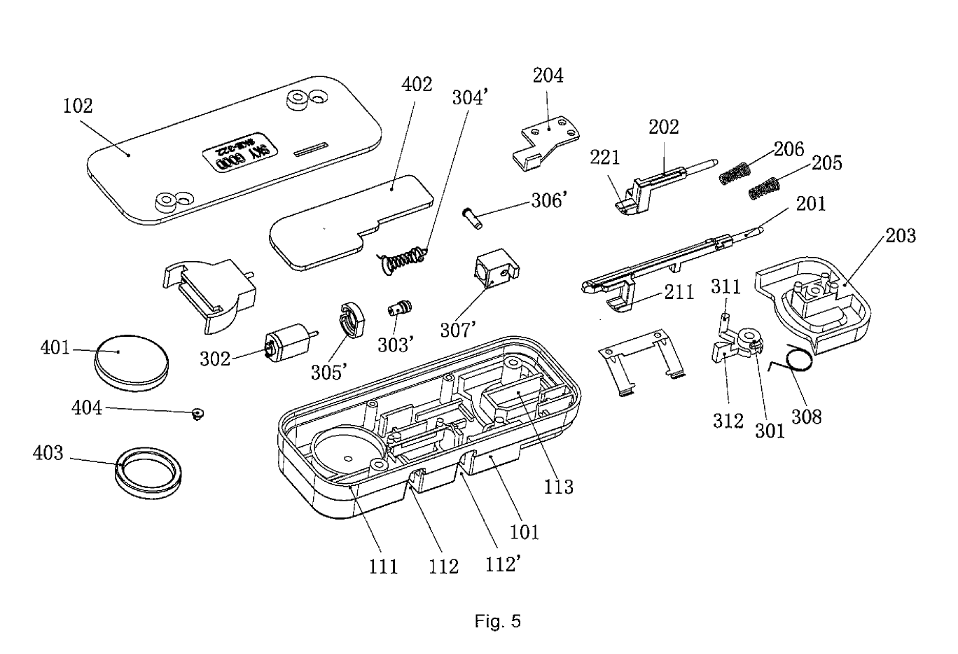

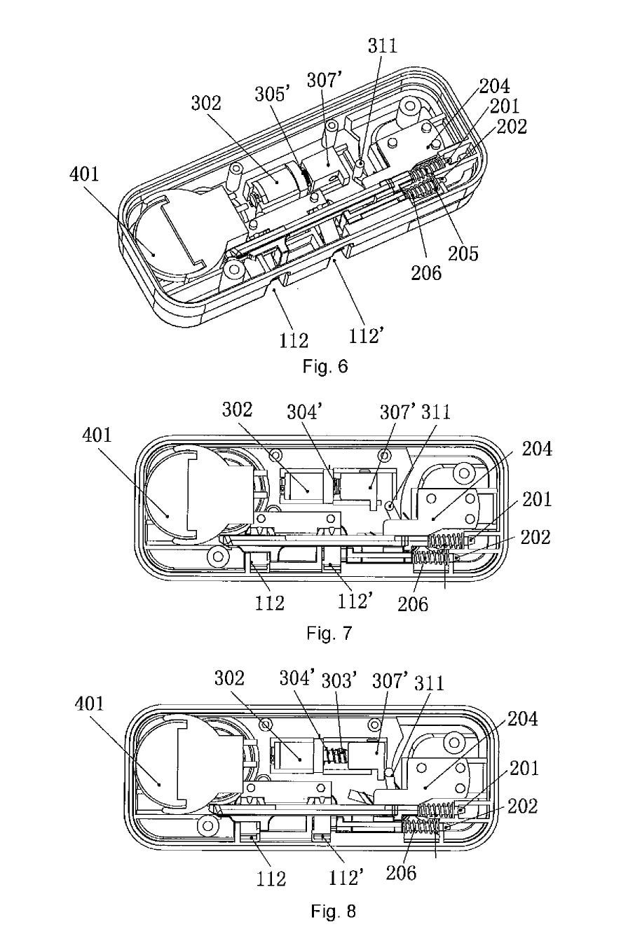

This embodiment is different to the first embodiment regarding the pushing component of the motor component. As shown in FIG. 5 and FIG. 6, in this embodiment, the motor component comprises a motor 302, a turbine 303 provided on the motor rotating shaft and a pushing component drove by the turbine 303. The pushing component comprises a push spring 304′ and a push block 307′. The push spring 304′ is fitted onto the turbine 303′, wherein the back end of the push spring 304 is fitted and mounted on the mounting cover 305′ of the motor 302, the front end of push spring 304′is mounted to the push block 307′by screw 306′.

The principle of operation of the motor component is:

The motor 302 rotates and drives the turbine 303′ to make clockwise or counterclockwise rotation, which makes the push spring 304′ extend or contract in length, thus the push block 307′moves forward or backward.

As shown in FIG. 7, lockup state: The push block 307′ releases the swing arm 311 of the rotating stop block 301, the driving spring 308 is in initial condition, the swing arm 312 of the rotating stop block 301 sets against the first pull rod 201 and the second pull rod 202, both of which are locked and cannot move.

As shown in FIG. 8, unlock state: The push plate 307′ pushes against the swing arm 311 of the rotating stop block 301, the swing arm 312 of the rotating stop block 301 leaves the first pull rod 201 and the second pull rod 202. Users can pull the unlock pulling plate 203 to drive the first pull rod 201 and the second pull rod 202.

### The Third Embodiment

In the embodiment, an electromagnetic induction (/Rifidi) component is provided, which controls the operation of a locking component, thus simultaneously two buckle lock sets are controlled.

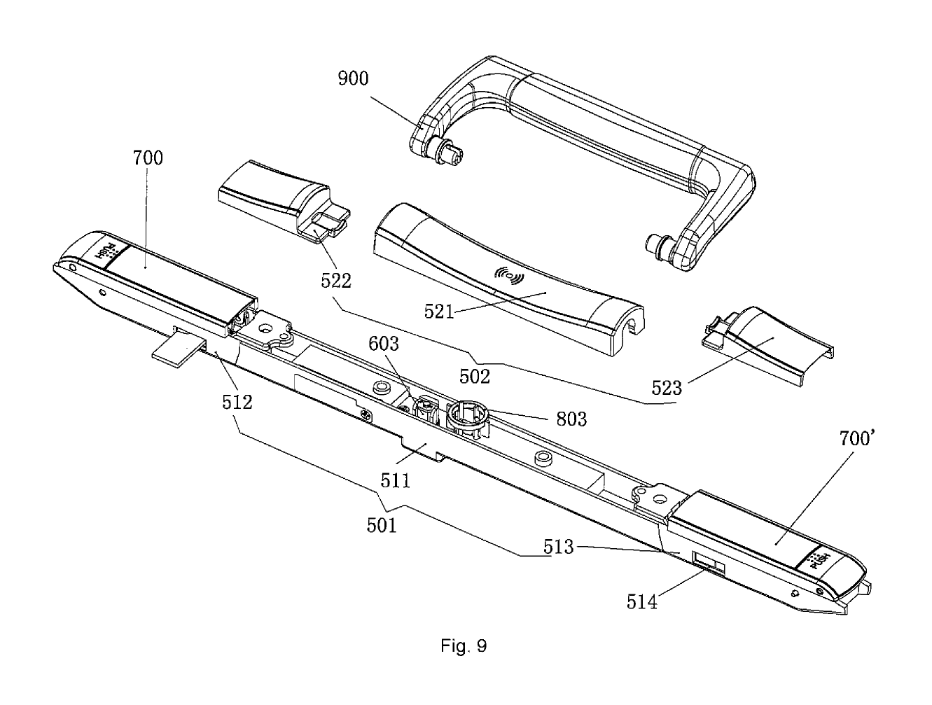

As shown in FIG. 9 to FIG. 16, as a matter of convenience in description, the direction to the locking component 600 is defined as inside of the embodiment. The embodiment provide an electromagnetic induction (/Rifidi) suitcase (including luggage & bag) lock, which comprises a shell, a locking component 600 arranged in the shell, a couple of buckle lock sets 700 and 700′ respectively and symmetrically provided on each far side of the locking component 600, and an electromagnetic induction (/Rifidi) component fitted in the shell.

As shown in FIG. 9, the shell comprises a base 501 and a top cover 502 on the base 501, wherein the base 501 comprises a middle base 511, two wing bases 512 and 513 respectively connected to each side of the middle base 511. The two wing bases 512 and 513 are both provided with a lockup opening 514. The top cover 502 comprises a middle cover 521, and two side covers 522 and 523.

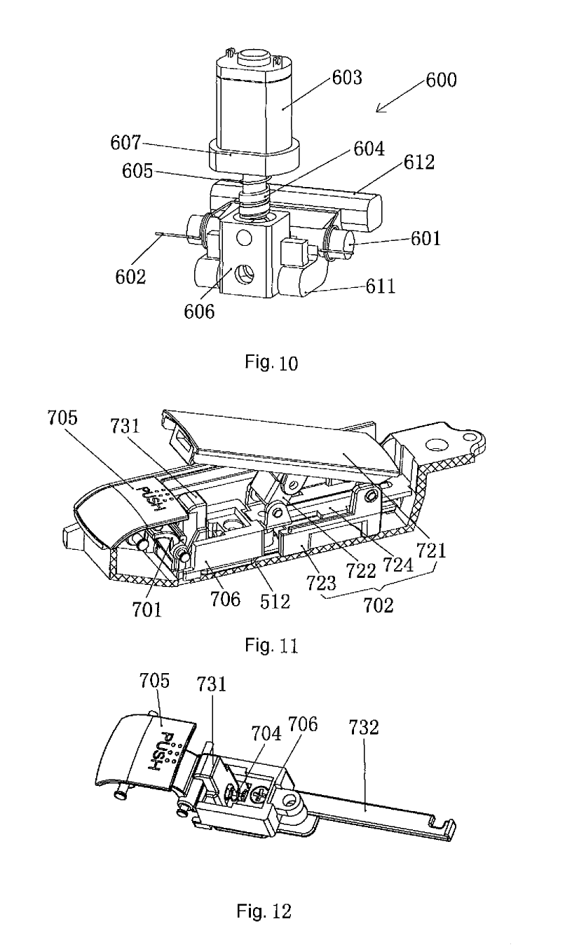

As shown in FIG. 10, the locking component 600 comprises a motor component, a rotating stop block 601 provided with two swing arms 611 and 612, and a driving spring 602, wherein the motor component comprises a motor 603, a turbine 604 provided on the motor rotating shaft and a pushing component drove by the turbine 604. The pushing component comprises a push spring 605 and a push block 606, wherein the push spring 605 is fitted onto the turbine 604, the back end of the push spring 605 is fitted and mounted on the mounting cover 607 of the motor 603, the front end of push spring 605 is mounted to the push block 606. The motor component drives the rotating stop block 601 in coordination with the driving spring 602; the motor component is fitted in the middle of the base 501, in the way of the motor 603 being in upper position and the rotating stop block 601 being in lower position. Regarding the principle of operation of the motor component, please refer to the second embodiment.

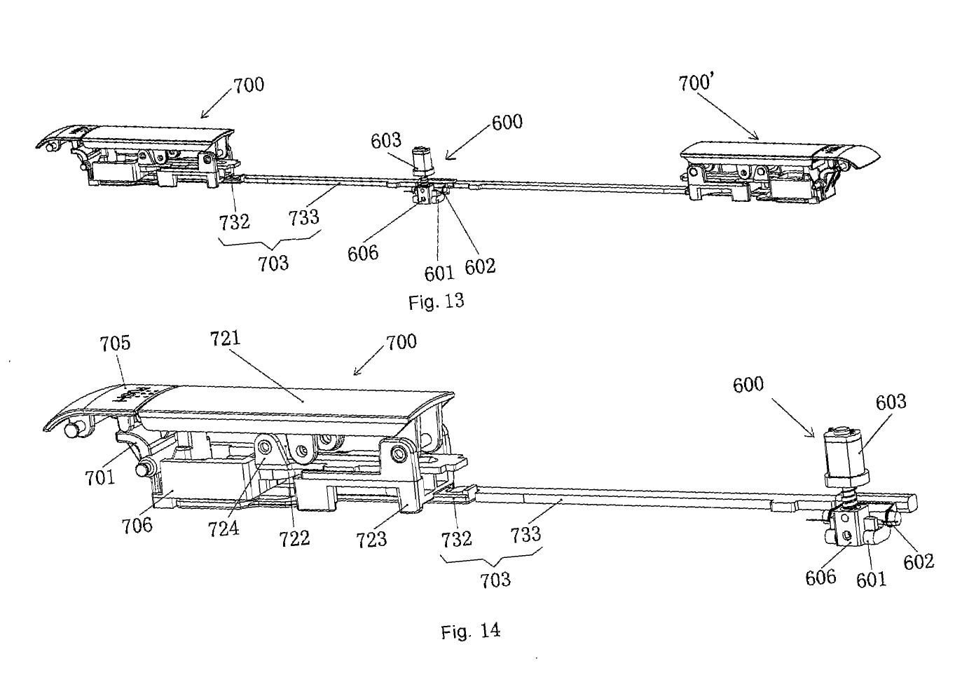

As shown in FIG.13, the two buckle lock sets 700 and 700′ are provided in base 501, wherein the buckle lock set 700 is fitted on the middle base 511 and wing base 512; the buckle lock set 700′ is fitted in the middle base 511 and wing base 513.

As shown in FIG. 11 to FIG.14, each buckle lock set (700 or 700′) comprises a rotatable torque part 701, a buckling linkage structure 702 used to buckle the parts to be locked, a linkage plate 703, a return spring 704 used to drive the linkage plate 703 to lockup the buckling linkage structure 702 and set against the torque part 701′, and a push button 705 used to press the torque part 701 which accordingly drives the linkage plate 703 to release the buckling linkage structure 702. The linkage plate 703 is provided with a trip 731 at the outer end is fitted on the footwall of base 501, particularly the linkage plate 703 consists of two shuffle bars 732 and 733, both of which are buckled and connected with each other, wherein the shuffle bar 732 is provided with the trip 731 on the outer end. In order to restrict the upward offset of the linkage plate 703, an additional stopper 706 mounted on base 501 is provided over the linkage plate 703, while the return spring 704 is provided between the trip 731 and stopper 706.

The two buckle lock sets 700 and 700′are respectively arranged at each side of the locking component 600, which locks or releases the two linkage plates 703 simultaneously. In particular, the linkage plates 703 of the two buckle lock sets 700 and 700′ are respectively arranged on each outer side of the swing arm 612 of the rotating stop block 601 of the locking component 600, wherein the rotating stop block 601 simultaneously lockup or release the two the linkage plates 703.

As shown in FIG.11, the buckling linkage structure 702 comprises a lock cover 721, an elastic joint plate 722, and a side lock latch hook 723 used to buckle the parts to be locked in the lockup opening 514. The lower end of the elastic joint plate 722 is rotationally connected to the shell (particularly connected a fixed joint plate 724 on the base 501) and located over the linkage plate 703, while the upper end of the elastic joint plate 722 is rotationally connected to the middle of the side lock cover 721. The inside end of the side lock cover 721 is rotationally connected to the side lock latch hook 723, while the outer end of the side lock cover 721 is in coordination with the trip 731 of the linkage plate 703. The torque part 701 is mounted on base 501 and located at the outside of the linkage plate 703 (also located at the outside of trip 731), the push button 705 is mounted on base 501 and locates on the upper end of the torque part 701. The side lock cover 721 closes and drives the side lock latch hook 723 to buckle the parts to be locked and compress the elastic joint plate 722, the elastic joint plate 722 repositions and pushes the side lock cover 721 open, which then drives the side lock latch hook 723 to release the parts to be locked.

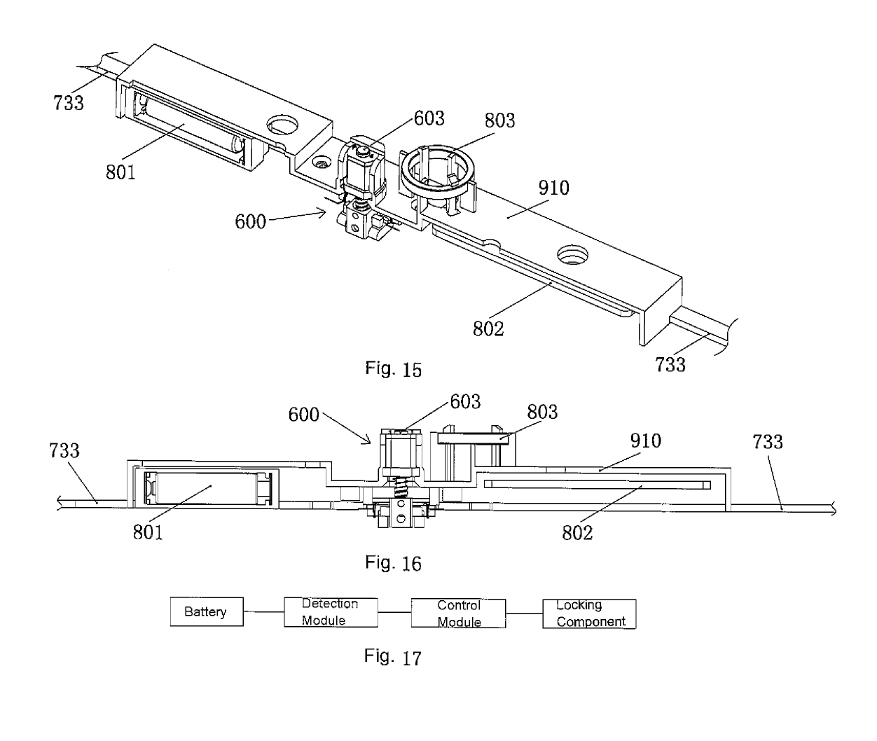

As shown in FIG. 15 and FIG. 16, the electromagnetic induction (/Rifidi) component comprises a battery providing working power supply 801, a control circuit board 802 and an induction (/Rifidi) coil 803 connected with the control circuit board 802. The control circuit board 802 controls the locking component 600 according to the signal induced by the induction (/Rifidi) coil 803, particularly controlling the operation of motor 603.

As shown in FIG. 15 and FIG. 16, for the sake of convenient installation, the base 501 is provided with a support 910, wherein the battery 801 and the motor 603 are both fitted on the support 910.

As shown in FIG, 9, a suitcase (including luggage & bag) handle 900 is also provided in the embodiment, wherein the left end of the suitcase (including luggage & bag) handle 900 is held and fixed by the side cover 522 and middle top cover 521, the right end of the suitcase (including luggage & bag) handle 900 is held and fixed by the side cover 523 and middle top cover 521.

The embodiment is generally installed at the lower cover of the suitcase (including luggage & bag), in coordination with the latch hook (the parts to be locked) of the lower cover. The principle of operation is:

Lock up process: Firstly the compatible magnetic card is placed close to the induction (/Rifidi) coil 803 so that the electromagnetic induction (/Rifidi) component receives a signal and controls the motor 603 to rotate, which ensures that the push block 606 releases the swing arm 611 of the rotating stop block 601 (push button 705 is then be able to be pressed), thus the swing arm. 612 of the rotating stop block 601 rotates downward at the function of the driving spring 602, that means the unlock state is verified before lockup. The push button 705 is then pressed to drive the torque part 701, thus the linkage plate 703 is pushed to make the trip 731 not hitch the side lock cover 721, which is then open. After that, the parts to be locked are inserted from the lockup opening 514 and placed at the side lock latch hook 723, then the side lock cover 721 is pushed down and pulls the side lock latch hook 723 to hitch the parts to be locked. The compatible magnetic card is then placed close to the induction (/Rifidi) coil 803 so that the electromagnetic induction (/Rifidi) component receives a signal and controls the motor 603 to rotate, which drives the push block 606 to press the swing arm 611 of the rotating stop block 601 down, accordingly the swing arm 612 of the rotating stop block 601 rotates upward and sets against the linkage plate 703 of the two buckle lock sets 700 and 700′, thus the linkage plate 703 is locked and cannot move. The linkage plate 703 sets against the torque part 701, thus the push button 705 cannot be pressed, and lockup is completed.

Unlock process: The compatible magnetic card is placed close to the induction (/Rifidi) coil 803 so that the electromagnetic induction (/Rifidi) component receives a signal and controls the motor 603 to rotate, which drives the push block 606 to release the swing arm 611 of the rotating stop block 601, accordingly the swing arm 612 of the rotating stop block 601 rotates downward at the function of the driving spring 602 and leaves the linkage plate 703 of the two buckle lock sets 700 and 700′, thus the linkage plate 703 is not locked and the purpose of unlock is achieved.

As shown in FIG. 17, in order to avoid the inconvenience of being unable to unlock when the battery runs out of power, the control circuit board is provided with a low voltage detect circuit, which comprises a detection module used for detecting the voltage of the battery 801 and a control module used for controlling the locking component 600 to release the buckle lock sets 700 and 700′ when the voltage of the battery 801 is under the pre-set value. In particular, when the voltage of the battery 801 is under the pre-set value, the control module controls the motor 603 to rotate, which drives the push block 606 to release the swing arm 611 of the rotating stop block 601. Accordingly, the swing arm 612 of the rotating stop block 601 rotates downward at the function of the driving spring 602, and leaves the linkage plate 703 of the two buckle lock sets 700 and 700′, thus the linkage plate 703 is not locked and the purpose of unlock is achieved.

The present invention is not limited to above embodiments, any simple replacement that based on above embodiments or any simple replacement without creative works should be within the scope disclosed by the invention.

1. An electromagnetic induction (/Rifidi) suitcase (including luggage & bag) lock comprising a shell, which is characterized by that it also comprises:
at least one buckle lock set arranged in the shell, which is used to buckle the parts to be locked;
a locking component arranged in the shell, which is used to lock or release the buckle lock set;
and an electromagnetic induction(/Rifidi) component arranged in the shell, which is used to sense the signal and thus control the operation of the locking component.

2. The electromagnetic induction (/Rifidi) suitcase (including luggage & bag) lock according to claim 1, which is characterized in that the locking component comprises a motor component controlled by the electromagnetic induction (/Rifidi) component, a rotatable rotating stop block and a driving spring, wherein the motor component drives the rotating stop block in coordination coordinate with the driving spring, thus locking or releasing the buckle lock set.

3. The electromagnetic induction (/Rifidi) suitcase (including luggage & bag) lock according to claim 2, which is characterized in that the motor component comprises a motor controlled by the electromagnetic induction (/Rifidi) component, a turbine provided on the motor shaft and a pushing component driven drove by the turbine; the pushing component drives the rotating stop block in coordination with the driving spring, thus locking or releasing the buckle lock set.

4. The electromagnetic induction (/Rifidi) suitcase (including luggage & bag) lock according to claim 3, which is characterized in that the pushing component comprises a driving elastic component provided with a ring and a double-arm connected with the ring, a guide lever, a hollow “H” shaped guide wheel and a push plate, wherein the guide lever and the push plate are respectively fitted on each side of the turbine; the guide wheel is fitted through the guide lever; the ring of driving elastic component is fitted over the guide wheel; the double arm of the driving elastic component is placed to hold the turbine and fitted on the pushing plate; the push plate drives the rotating stop block in coordination with the driving spring, thus locking or releasing the buckle lock set.

5. The electromagnetic induction (/Rifidi) suitcase (including luggage & bag) lock according to claim 3, which is characterized in that the pushing component comprises a push spring and a push block, wherein the push spring is fitted onto the turbine with one end fixed and another end fixed on the push block; the push block drives the rotating stop block in coordination with the driving spring, thus locking or releasing the buckle lock set.

6. The electromagnetic induction (/Rifidi) suitcase (including luggage & bag) lock according to claim 1, which is characterized in that the electromagnetic induction (/Rifidi) component comprises a battery providing working power supply, a control circuit board and an induction (/Rifidi) coil connected with the control circuit board.

7. The electromagnetic induction (/Rifidi) suitcase (including luggage & bag) lock according to claim 6,which is characterized in that the electromagnetic induction (/Rifidi) component also comprises an indicating light provided with two kinds of indication state and connected with the control circuit board.

8. The electromagnetic induction (/Rifidi) suitcase (including luggage & bag) lock according to claim 6, which is characterized in that the control circuit board is provided with a low voltage detect circuit, wherein the low voltage detect circuit comprises a detection module used for detecting the voltage of the battery and a control module used for controlling the locking component, thus the buckle lock set is released when the battery voltage is under the pre-set value.

9. The electromagnetic induction (/Rifidi) suitcase (including luggage & bag) lock according to claim 1, which is characterized in that the buckle lock set comprises:
a buckling component used for buckling the parts to be locked;
an unlock pulling plate arranged in the shell which is pulled by user from outside of the shell thus the buckling component is correspondingly pulled and the parts to be locked are released; and
a return spring component arranged in the shell, which is used for driving the buckling component to buckle the parts to be locked;
the locking component locks or releases the buckling component.

10. The electromagnetic induction (/Rifidi) suitcase (including luggage & bag) lock according to claim 9, which is characterized in that the buckling component comprises a first pull rod with a first buckle and a second pull rod with a second buckle, while the return spring component comprises a first return spring connected with the first pull rod and a second return spring connected with the second pull rod.

11. The electromagnetic induction (/Rifidi) suitcase (including luggage & bag) lock according to claim 1, which is characterized in that the buckle lock set comprises:
a rotatable torque part;
a buckling linkage structure used to buckle the parts to be locked;
a linkage plate, which is provided with a trip used to lock the buckling linkage structure;
a return spring used to drive the linkage plate to lock the buckling linkage structure and set against the torque part; and
And a push button used to press the torque part which accordingly drives the linkage plate to release the buckling linkage structure;
the locking component locks or releases the linkage plate.

12. The electromagnetic induction (/Rifidi) suitcase (including luggage & bag) lock according to claim 11, which is characterized in that the buckling linkage structure comprises a lock cover, an elastic joint plate and a side lock latch hook used to buckle the parts to be locked, wherein the fixed joint plate is mounted in the shell; one end of the elastic joint plate is rotationally connected to the fixed joint plate, another end of the elastic joint plate is rotationally connected to the middle of the side lock cover; one end of the side lock cover is rotationally connected to the shell, another end of the side lock cover is coordinated with the trip of the linkage plate; the side lock cover drives the side lock latch hook to buckle the parts to be locked and compress the elastic joint plate, whereas the elastic joint plate repositions and props the side lock cover, thus the side lock cover drives the side lock latch hook to release the parts to be locked.

13. The electromagnetic induction (/Rifidi) suitcase (including luggage & bag) lock according to claim 11, which is characterized in that the quantity of the buckle lock set is two, the two buckle lock sets are respectively arranged at each side of the locking component which lock or release the two linkage plates simultaneously.
